(19) United States
(12) Patent Application Publication
(10) Pub. No.: US 2002/0150167 A1
(43) Pub. Date: Oct. 17, 2002

(54) Methods and apparatus for configurable or assymetric forward error correction

(76) Inventors: Victor Demjanenko, Pendleton, NY (US); Juan Alberto Torres, Orchard Park, NY (US)

Correspondence Address: Ronald Coslick, FOLEY & LARDNER, Suite 3500, 2029 Century Park East, Los Angeles, CA, 90067-3021, US

(21) Appl. No.: 10/079,202

(22) Filed: Feb. 19, 2002

Related U.S. Application Data
(63) Continuation-in-part of application No. 09/744,790, now abandoned.
Application No. 09/744,790 is a 371 of international application No. PCT/US99/17369, filed on Jul. 30, 1999.
(60) Provisional application No. 60/269,746, filed on Feb. 17, 2001.
(60) Provisional application No. 60/282,097, filed on Apr. 7, 2001.

(51) Int. Cl. H04L 27/00

(52) U.S. Cl. 375/259

(57) ABSTRACT

The encoder of a communication device is configurable such that the encoder may operate in any of a variety of forward error correction modes. Further, for each mode, a variety of encoding parameters may be configured. The configurability of forward error correction modes and/or parameters enables communication devices to perform interactive configuration processes, whereby a communicating device specifies the type of forward error correction that the other is to perform. This configuration may be bidirectional, such that each device selects the forward error correction provided by the other. Each device may further configure its decoder to decode the forward error correction mode that it has selected for the other communication device. In other embodiments two communicating devices may implement two different modes of forward error correction.

### RELATED APPLICATIONS

This application claims the benefit under 35 U.S.C. Section 119(e) of U.S. Provisional Patent Application Serial No. 60/269,746, filed on Feb. 17, 2001, incorporated herein by reference in its entirety, and U.S. Provisional Patent Application Serial No. 60/282,097, filed on Apr. 7, 2001, incorporated herein by reference in its entirety.

This application is a continuation in part of U.S. patent application Ser. No. 09/744,790, filed on Jan. 30, 2001, which is a national stage filing of PCT/US99/1 7369, filed on Jul. 30, 1999, the entirety of each of which are incorporated herein by reference.

This application incorporates by reference the entire teachings of: U.S. patent application Ser. No. 09/846,061 entitled “Use of Turbo-like Codes for QAM Modulation Using Independent I and Q Decoding Techniques and Application to xDSL systems”; U.S. patent application Ser. No. 09/991,372 entitled “System and Method Using Multi-dimensional Constellations with Low Receiver Soft-Decision Extraction Requirements”; U.S. Patent Application PCT/US99/17369 entitled “Method and Apparatus for Design Forward Error Correction Techniques in Data Transmission Over Communications Systems”; and U.S. Provisional Patent Application Ser. No. 09/702,827 entitled “Use of Turbo Trellis codes with QAM Modulation for xDSL Modems and Other Wired and Wireless Modems.”

### FIELD OF THE INVENTION

Embodiments of the invention pertain to communication devices that utilize forward error correction, and in particular embodiments, to methods for their configuration.

### BACKGROUND TECHNOLOGY

Turbo Codes and other receiver soft-decision extraction techniques such as Low Density Parity Check Codes (LDPC) are powerful error control techniques that allow communication at very close to the channel capacity. Low Density Parity Check Codes were introduced in 1962. The sum-product algorithm is commonly used to decode LDPC codes. The sum-product algorithm sends information forward and backward between the information bits and the parity bits iteratively, until all the bits are decoded correctly or some bits are identified as incorrectly decoded. Consequently the sum-product algorithm provides bit error information that indicates which outputted decoded bits have errors.

LDPC encoders and decoders are conventionally used alone, and are not conventionally used in dual inner/outer coder arrangements. The efficiency of LDPC coding increases with the number of coded bits, and so conventional LDPC implementations have typically used large block sizes (e.g. one megabit) for encoding in order to achieve nearly error free operation (0.05 dB from capacity). However, since an entire block must be received before an LDPC decoder can decode the block, the use of large blocks can introduce delay into the system at the receiver.

Turbo Codes were introduced in 1993. Turbo-type decoders, also referred to herein as soft-output decoders, provide bit error probability information that indicates a probability of error for each of the decoded bits.

The use of an outer coder, such as a Reed-Solomon (RS) coder, in conjunction with an inner coder, enables errors remaining from an inner coder to be corrected by the outer coder. A RS decoder is able to correct up to R/2 errors without having information of the location of the errors. A RS decoder is able to correct up to R errors if the decoder knows where the errors are located. It is therefore desirable for an outer coder to have information indicating where errors are located. Thus the conventional outer decoder comprises two stages. The first stage receives an output bit stream from an inner decoder and determines which of the received bits have errors. The second stage uses the information generated by the first stage to selectively correct errors in the output bit stream of the inner decoder.

Examples of the use of inner and outer coders are found in the ADSL ITU recommendation G.992.1 and in the Third Mobile Generation Standard UMTS 3GPP 3G TS 25.212 V3.2.0.

Conventional communication devices are provided with one mode of forward error correction, and in some instances the devices may be manually configured to provide either that mode of forward error correction or no forward error correction. Thus conventional communications systems are symmetrical in that two communicating devices of the system use the same mode of forward error correction.

The following references are incorporated by reference as representing the conventional knowledge in the field of the invention:

“Near Shannon limit performance of low density parity check codes,” D. J. C. MacKay and R. M. Neal, Electron. Lett., vol. 32, no. 18, pp. 1645-1646, August 1996.

“Good error-correcting codes based on very sparse matrices,” D. J. C. MacKay, IEEE Trans. on Inform.Theory, vol. 45, No. 2, pp. 399-431, March 1999.

“Low-density parity-check codes,” R. G. Gallager, IRE Trans. Info. Theory, vol. IT-8, pp. 21-28, January1962.

S.-Y. Chung, G. D. Forney, T. J. Richardson, and R. Urbanke, “On the design of low-density parity-check codes within 0.0045 dB of the Shannon limit,” IEEE Communications Letters, Vol. 5, No.2, pp. 58-60, February 2001.

C. Berrou, V. Glavieux and P. Thitimajshima, “Near Shannon limit error-correcting coding and decoding: turbo-codes”, ICC 1993, Geneva, Switzerland, pp. 1064-1070, May 1993.

H. Feldman and D. V. Ramana, “An introduction to Inmarsat's New Mobile Multimedia Service”, The Sixth International Mobile Satellite Conference, Ottawa, pp. 226-229, June 1999.

P. Chaudhury, W. Mohr and S. Onoe, “The 3GPP Proposal for IMT-2000”, IEEE Communications Magazine, vol. 37, no 12, pp.72-81. December 1999.

3GPP Standard “Multiplexing and channel coding: TS 25.212”

C. D. Edwards, C. T. Stelzried, L. J. Deutsch and L. Swanson, “NASAS's deep-Space Telecommunications Road Map” TMO Progress Report 42-1 36, JPL, Pasadena, Calif. USA. PP. 1 -20 February 1999.

R. Pyndiah, A. Picard and A. Glavieux “Performance of Block Turbo Coded 16 QAM and 64 QAM modulations” Procedings of Globecom 95 pp.1039-1043.

Rauschmayer, Dennis J. “ADSL/VDSL Principles”, Macmillan Technical Publishing, 1999.

ITU G.992.1 “ADSL Transceivers”, ITU, 1999.

ITU G.992.2 “Splitterless ADSL Transceivers”. ITU 1999.

ITU I.432 “B-ISDN user-network interface-physical layer specification”, ITU, 1993.

Benedetto, Divsalar, Montorsi and F. Pollara, “Serial Concatenation of Interleaved Codes: Performance Analysis, Design, and Iterative Decoding”, The Telecommunications and Data Acquisition Progress Report 42-126, Jet Propulsion Laboratory, Pasadena, Calif., pp. 1-26, Aug. 15, 1996.

Benedetto, Divsalar, Montorsi and F. Pollara, “A Soft-Output Maximum A Posteriori (MAP) Module to decode parallel and Serial Concatenated Codes”, The Telecommunications and Data Acquisition Progress Report 42-1 27, Jet Propulsion Laboratory, Pasadena, Calif., pp. 1-20, Nov. 15, 1996.

L. R. Bahl, J. Cocke, F. Jelinek, and J. Raviv, “Optimal Decoding of Linear Codes for Minimizing Symbol Error Rate,” IEEE Transactions on Information Theory, pp. 284-287, March 1974.

Divsalar and F. Pollara, “Turbo Codes for PCS Applications”, Proceedings of ICC'95, Seattle, Wash., pp. 54-59, June 1995.

D. Divsalar and F. Pollara, “Multiple Turbo Codes”, Proceedings of IEEE MILCOM95, San Diego, Calif., Nov. 5-8, 1995.

D. Divsalar and F. Pollara, “Soft-Output Decoding Algorithms in iterative Decoding of Turbo Codes,” The Telecommunications and Data Acquisition Progress Report 42-1 24, Jet Propulsion Laboratory, Pasadena, Calif., pp. 63-87, Feb. 15, 1995.

D. Chase “A class of algorithms for decoding block codes” IEEE trans. IT, Vol. IT-18, pp. 170-182, January 1972.

R. Pyndiah “Near Optimum decoding of Product Codes: Block turbo Codes”, IEEE Trans. On Comm., Vol. 46, No. 8, pp.1003-1010, August 1998.

### SUMMARY OF THE INVENTION

In accordance with certain embodiments of the invention, the encoder of a communication device is configurable such that the encoder may provide any of a variety of forward error correction modes. Further, for each mode, a variety of encoding parameters may be configured.

The configurability of forward error correction modes and parameters enables communication devices to perform interactive configuration processes, whereby a communicating device specifies the type of forward error correction that the other is to perform. This configuration may be bidirectional, such that each device selects the forward error correction provided by the other. Each device may further configure its decoder to decode the forward error correction mode that it has selected for the other communication device.

In accordance with other embodiments of the invention, two communicating devices may implement two different modes of forward error correction. Thus each device encodes a transmitted signal using one mode, and decodes a received signal that has been encoded using a different mode. Such an asymmetrical coding scheme may be manually configured, or may be the result of an interactive configuration process as described above.

Examples of modes of forward error correction modes that may be configured in preferred embodiments include convolutional coding (CC), trellis code modulation (TCM), full turbo-like code (FTLC), multilevel turbo-like code (MTLC), full Low-Density Parity Check codes (FLDPC) and Multi-Level Low Density Parity Check Code (MLDPC). In one preferred embodiment, turbo-like codes may be implemented in single, double or triple turbo encoder configurations, using 4, 8 or 16 state convolutional encoders. For the case of Turbo-like codes in a Discrete Multi-Tone (DMT) system, a preferred interleaver size is an integral number of DMT symbols, and assignment of parity/information bits for greater protection with QAM modulations in a DMT system. For the case of LDPC codes in a DMT system a preferred dimension of the parity check matrix size is an integral number of DMT symbols. Examples of parameters that are configurable in preferred embodiments include: how many bits will be encoded (0, 1, 2, . . . all); which bits are more protected (parity or information bits); how many states used in the convolutional encoder (4, 8 or 16) for the case of Turbo-like codes; how many convolutional encoders are used (one, two or three) for the case of Turbo-like codes; and how many DMT symbols is the size of the interleaver (1 to n) and parity check matrix, for the case of a DMT system.

### BRIEF DESCRIPTION OF THE DRAWINGS

FIG. 1 shows a block diagram of the algorithm proposed.

FIG. 2 shows Multi-level Gray mapping for 4-ASK, 8-ASK and 16-ASK.

FIG. 3 shows a block diagram of the NC operation mode.

FIG. 4 shows a block diagram of the TCM operation mode.

FIG. 5 shows a block diagram of the FTLC operation mode.

FIG. 6 shows a block diagram of the FTLC-PCCC operation mode in accordance with a first preferred embodiment.

FIG. 7 shows a block diagram of the FTLC-PCCC operation mode with 2 interleavers in accordance with a first preferred embodiment.

FIG. 8 shows a block diagram of the FTLC-TPC operation mode in accordance with a second preferred embodiment.

FIG. 9 shows a block diagram of the FTLC-LDPC operation mode in accordance with a second preferred embodiment.

FIG. 10 shows a block diagram of the MTLC operation mode in accordance with a second preferred embodiment.

FIG. 11 shows a block diagram of the MTLC-PCCC operation mode in accordance with a second preferred embodiment.

FIG. 12 shows a block diagram of the MTLC-PCCC operation mode using two interleavers in accordance with a second preferred embodiment.

FIG. 13 shows a block diagram of the MTLC-TPC operation mode in accordance with a second preferred embodiment.

FIG. 14 shows a block diagram of the MTLC-LDPC operation mode in accordance with a second preferred embodiment.

FIG. 15 shows a block diagram of a communication device encoding scheme in accordance preferred embodiments.

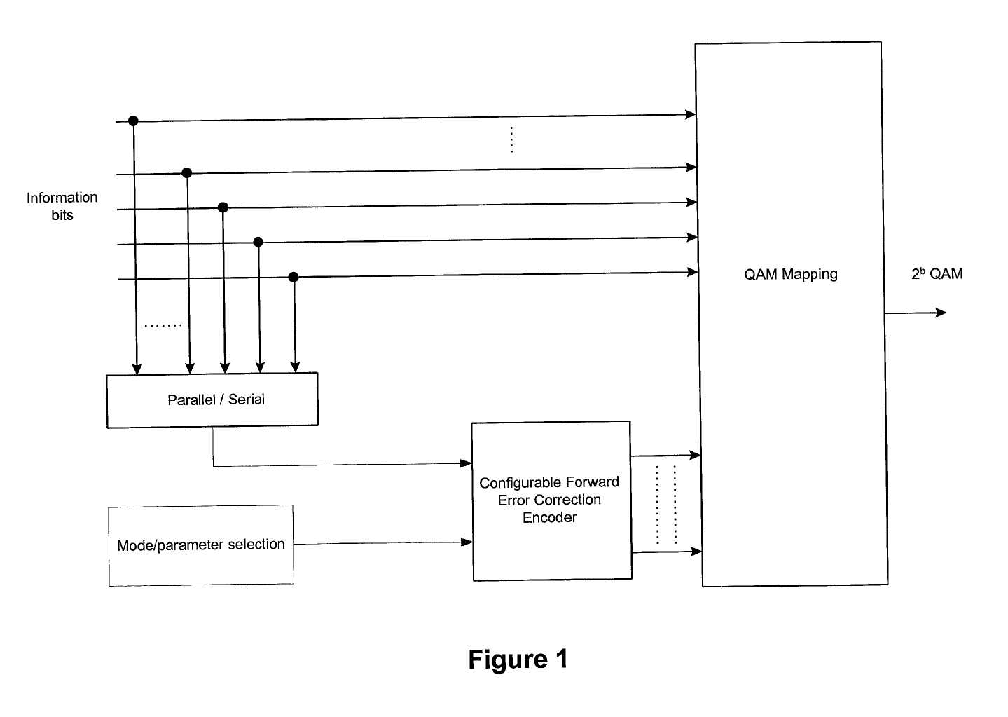

FIG. 1 6 shows an interactive configuration process involving two communicating devices.

### DETAILED DESCRIPTION OF PREFERRED EMBODIMENTS

In the following description, details of preferred embodiments and certain alternative embodiments in accordance with the invention are set forth. However, it will be apparent to those of ordinary skill in the art that alternative embodiments of the invention may be implemented using only some of the features of these embodiments, and using alternative combinations of the features of these embodiments. While various operations may be described herein in a particular order and as discrete tasks, the order of description should not be construed to imply that the tasks involved in those operations must be performed in the order in which they are presented or that those tasks must be performed discretely. Further, in some instances, well known features are omitted or generalized in order not to obscure the description. In this description, the use of phrases such as “an embodiment,” “embodiments,” “preferred embodiments,” “alternative embodiment” and so forth do not necessarily refer to the same embodiment or all embodiments, although they may.

Definitions

In this application, the term “no coding” is used in the sense that all bits are sent uncoded to the channel. The term “Trellis Code Modulation” is used in the sense that only two bits are encoded in the constellations, and these two bits are used for coset discrimination in the manner defined in ITU Recommendation G.992.1 for the cases of a DMT system. The term “full turbo-like code” is used in the sense that all the information bits are encoded using a turbo-like process. The term “multilevel turbo-like code” is used in the sense that some bits are coded using a turbo-like process, depending on the order of the QAM constellation, and the remaining bits are sent uncoded. In the case of turbo-like codes, the term single, double or triple turbo coding indicates how many convolutional encoders are used. Single turbo coding provides Trellis Code Modulation, double coding provides classic turbo coding with one interleaver, and triple coding uses of two interleavers and three convolutional encoders.

Providing more protection to information bits describes mapping bits such that the probability of the information bits having an error is lower than the probability of the parity bits having an error. Providing more protection to the parity bit(s) describes mapping bits such that the probability of the parity bit(s) having an error is lower than the probability of the information bits having an error.

1. Introduction

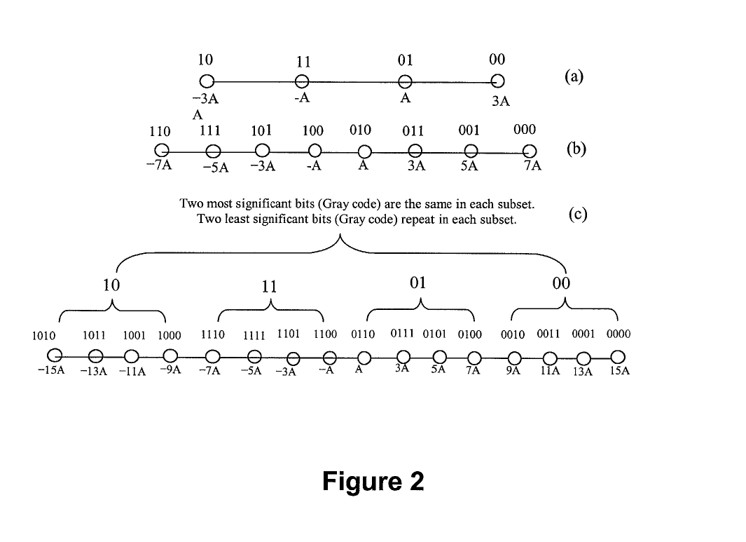

FIG. 1 shows a block diagram of the encoding portion of a communication device in accordance with preferred embodiments of the invention. The encoding portion includes a configurable forward error correction encoder that is configurable in response to mode selection and parameter selection signals. Depending on the operation mode selected, all bits may be sent with: (1) No Coding (NC), (2) Trellis Code Modulation (TCM), (3) Full Turbo-Like Code (FTLC) or (4) Multilevel Turbo-Like Code (MTLC). The QAM constellation is used with gray mapping in the cases that any full turbo-like coding is utilized. In the case of multilevel codes multilevel-gray mapping of the type shown in FIG. 2 is used.

In the case of a DMT system when TCM is used the constellation and mapping defined in G.992.1 is also used.

For an even number of bits, in the case of Full Turbo or Multilevel Turbo coding, square constellations are used with Gray mapping in the way that was indicated in the U.S. patent application Ser. No. 09/846,061 entitled “Use of turbo-like codes for QAM modulation using independent I and Q decoding techniques and application to xDSL systems”. In these cases, the mapping uses independent I and Q, that simplifying the decoding process.

For odd number of bits, for any modulation encoder, the constellations and mapping used is described in the U.S. patent application Ser. No. 09/991,372 entitled “System and method using multi-dimensional constellations with low receiver soft-decision extraction requirements”, which is incorporated herein by reference.

The mapping of the bits to constellation indices is either from the bottom to the top or from the top to the bottom. In the illustrated embodiment, if mapping is from the bottom to the top, the parity bits are more protected, and if mapping is from the top to the bottom, the information bits are more protected.

For applications with a target BER below 10⁻⁷ in an Additive White Gaussian Noise (AWGN) channel, it is better to protect more the parity bits. For applications with a target BER higher of 10⁻⁷, the protection of the information bits is more important in an AWGN channel. For Impulse noise channels, the greater protection of parity bits provides better performance in all cases.

This technique is applicable to the implementation of DMT xDSL modems. In these systems, the number of carriers can vary from 100 (ADSL) to 4,094 (VDSL). For this reason, the amount of data processing required to process these carriers also varies in a wide range.

If full turbo-like coding is used, the amount of data processing for the case of the VDSL 4,096 carriers could be prohibitive. For this reason, a multilevel turbo-like coding may be used, where only some of the information bits are coded and the data processing can be more efficiently handled.

The QAM constellations that may be used may vary from 2 QAM (1 bit constellation) up to 32768 QAM (15 bits constellations) or higher.

2. Description of configurable forward error correction modes

The preferred embodiments of the invention are configurable to provide multiple forward error correction modes as described in the following subsections. One application of the invention pertains particularly to xDSL systems, as a representative of DMT wired-based systems. Another application is multicarrier wireless DMT systems that uses multi-carriers, such as Orthogonal Frequency Division Multiplex (OFDM) systems. The mode to which a communication device is configured may depend on a variety of considerations.

Full turbo-like coding ensures a minimum acceptable data rate for very low signal to noise ratios that are not possible with other known error correction techniques. This mode is typically used good for long loops, loops with high interference, and loops with bridge taps for example.

Multilevel turbo-like coding allows a good data rate when the data processing available does not allow the use of a full turbo-like code. This mode may be preferred in the VDSL case where the number of carriers is 4,096. The performance is less than full turbo-like encoding, but the number of bits to be decoded is also less.

The mapping preferred for any turbo encoding mode is Gray mapping because of its superior performance, however, other mappings can be used. Gray mapping for full turbo-like and LDPC codes is defined in the U.S. patent application Ser. No. 09/846,061 entitled “Use of turbo-like codes for QAM modulation using independent I and Q decoding techniques and application to xDSL systems”. Multi-level gray mapping for multi-level turbo-like and multi-level LDPC codes is shown in FIG. 2. For the case of NC and TCM, the mapping used could be the one defined in G.992.1 for interoperability issues.

Typically modes involving a low number of convolutional encoder states involve less computational complexity but provide lower performance. In contrast, modes involving a high number of convolutional encoder states require more computational complexity, but provide better performance.

Larger interleave sizes provide better performance but more latency.

For applications with a target BER below 10⁻⁷ in an AWGN channel, it is preferred to protect the parity bits more. For applications with a target BER higher than 10⁻⁷ the protection of the information bits is more important in an AWGN channel. For Impulse noise channels, the greater protection of parity bits provides better performance in all cases.

2.1 No coding (NC)

NC operation applies no forward error correction encoding to the signal. For purposes of distinguishing the forward error correction modes described herein, NC operation is not considered a mode of forward error correction per se, because no forward error correction encoding is performed. Rather, bits sent to the Parallel/Serial device are not used, and the inputs to the QAM modulator from the convolutional encoders are not taken into account. No coding operation is typically used where there is only a short distance between devices.

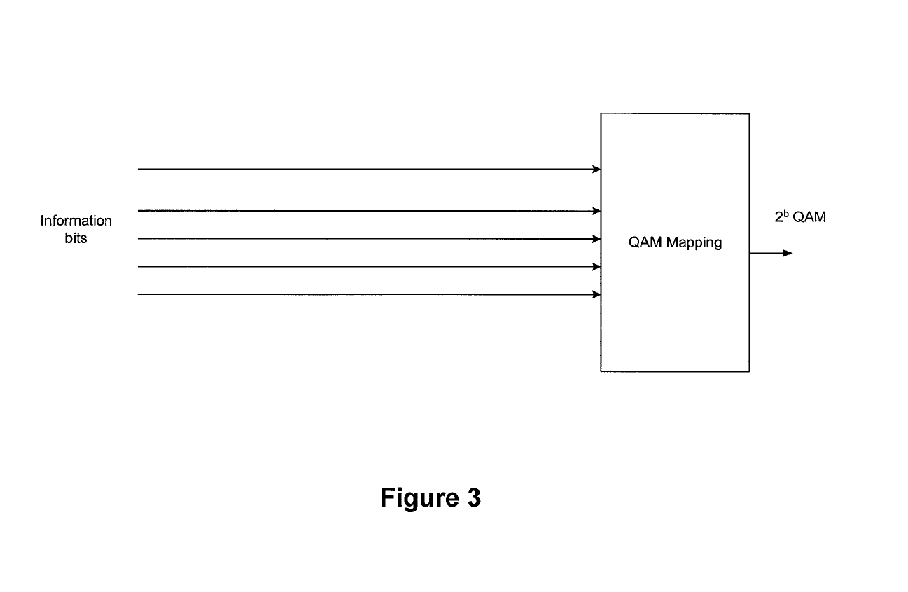

FIG. 3 shows a block diagram of the system described. In the NC operation all the bits are sent with no coding. In this operation, for a spectral efficiency of 4 bit/s/Hz, a signal to noise ratio of 21.5 dB for a BER of 10⁻⁷ is needed. This is equivalent to Energy of bit to Noise ratio (Eb/No) of 15.5 dB. For a spectral efficiency of 12 bit/s/Hz, a signal to noise ratio (SNR) of 45.5, dB for a BER of 10⁻⁷ is needed. This is equivalent to an Eb/No of 34.7 dB. These performance results are the same as G.992.2 and G.992.1 (1999) without TCM. The mapping used is the one described in ITU-T Recommendation G.992.1 (06/99) for backward compatibility. Other mappings are possible to increase the performance, but backward compatibility will not be possible.

2.2 TCM operation mode

The TCM operation mode is used when Trellis Code Modulation coding is applied to the signal, in the same manner as described in G.992.1 (06/99). In the preferred embodiment, three bits (U3, U2, U1) are sent to the Parallel/Serial device, and two of these three bits (U2, U1) are input to the Convolutional encoder described in G.992.1 (06/99), providing 3 output bits (U2, U1, U0) that are used to select one of eight possible 4-dimensional cosets. The additional bit, U3, determines which one of two Cartesian products of 2-dimensional cosets in the 4-dimensional coset is chosen. An alternative implementation may bypass the Parallel/Serial and Serial/Parallel steps and deliver only the low order information bits.

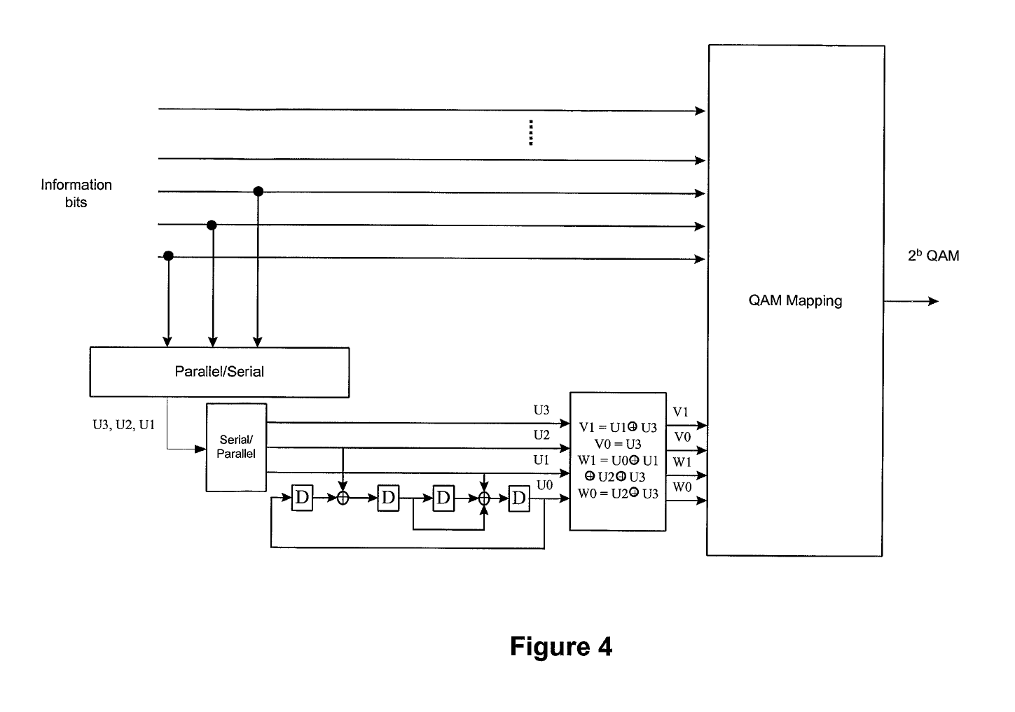

FIG. 4 shows a block diagram of the preferred embodiment in the TCM operation mode. In this operation mode, for a spectral efficiency of 4 bit/s/Hz, a SNR of 18.0 dB, for a BER of 10⁻⁷, is needed that is equivalent to Eb/No of 12.0 dB. For a spectral efficiency of 12 bit/s/Hz, a SNR of 42.0 dB, for a BER of 10⁻⁷, is needed. This is equivalent to Eb/No of 31.2 dB. The constellation mapping used is the one described in ITU-T Recommendation G.992.1 (06/99) for backward compatibility.

In the preferred embodiment a device may be configured to provide TCM coding using upon receiving a polynomial used in the convolutional code in octal. Alternatively the device may include a database associating convolutional coders and identifying codes, so that an identifying code can be used to indicate the number of a convolutional coders to be used.

2.3 FTLC operation mode

The FTLC operation mode is used when all the information bits are encoded in a turbo-like manner. With turbo-like, we refer to the use of soft decision decoding algorithm. In this operation mode, some sub-modes are possible such as the parallel concatenated convolutional codes, serial concatenated convolutional codes, Block Product codes, Low Density Parity Check codes, Repeat Accumulate Codes, etc . . .

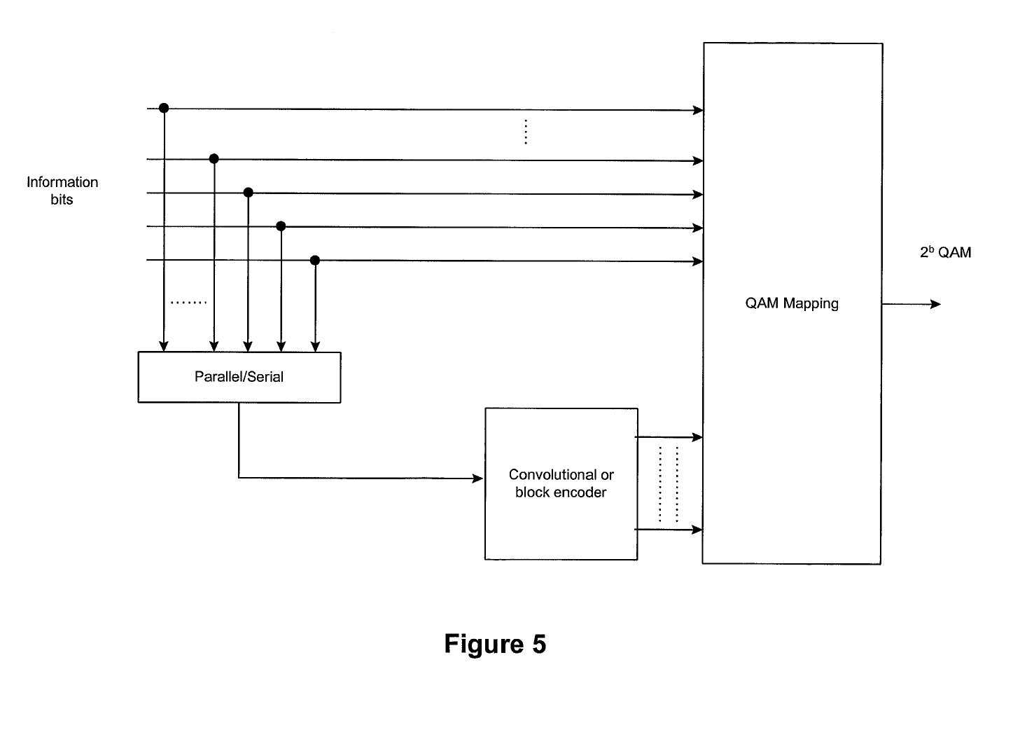

FIG. 5 shows a block diagram of the configuration of a communication device for the FTLC operation mode.

2.3.1 FLTC-PCCC operation mode

The FTLC-PCCC operation mode is used when all the information bits are encoded with Parallel Concatenated Convolutional Codes (PCCC). This operation mode is also known as traditional Turbo Code.

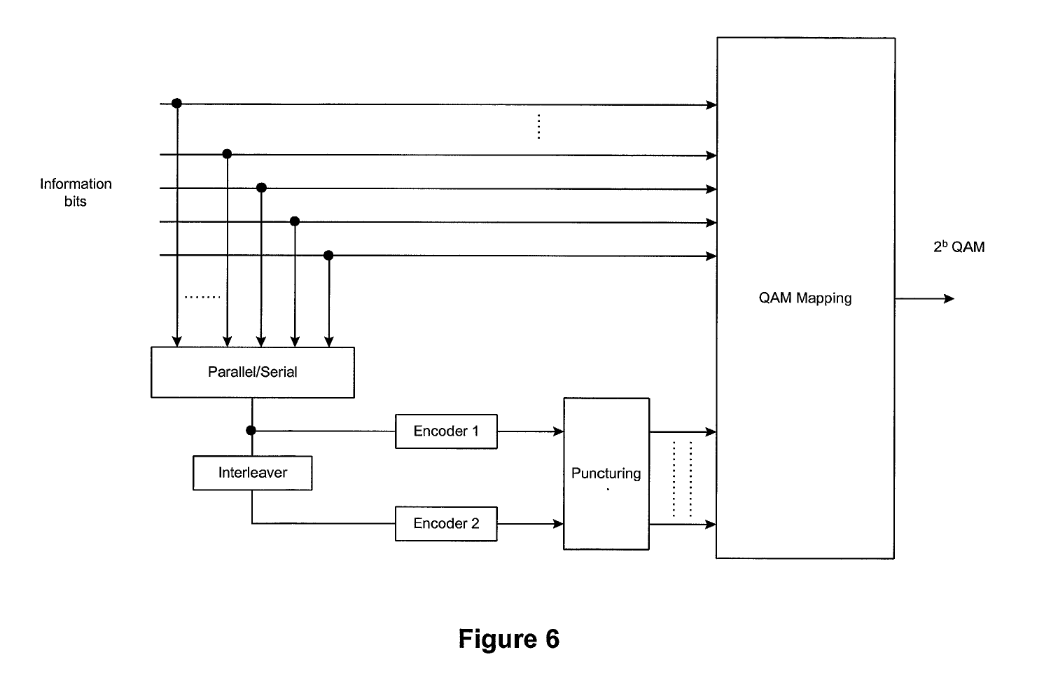

FIG. 6 shows a block diagram of the system described for FTLC-PCCC operation mode. All the information bits are sent to encoder 1 and to the interleaver. After the bits are interleaved, they are sent to encoder 2. The parity bits from encoder 1 and encoder 2 are sent to the Puncturing block, that according to a function of the QAM constellation used, selects a different puncturing pattern as described in the U.S. patent application Ser. No. 09/846,061 entitled “Use of turbo-like codes for QAM modulation using independent I and Q decoding techniques and application to xDSL systems” herein incorporated by reference. Encoder 1 and 2 can either of 4, 8 or 16 states.

The puncturing block selects the parity bits that are sent to the channel as described in the U.S. patent application Ser. No. 09/846,061 entitled “Use of turbo-like codes for QAM modulation using independent I and Q decoding techniques and application to xDSL systems”.

The interleaver block is designed to ensure a fixed latency in the system that provides the best performance. The length of the interleaver is variable depending on the data rate, and it is set to an integer multiple of DMT symbols. For practical implementations of the interleaver for latencies below 10 ms, the interleaver length may be set to 14 DMT symbols or a smaller integral number. A design of the interleaver can be found in the U.S. patent application Ser. No. 09/846,061 entitled “Use of turbo-like codes for QAM modulation using independent I and Q decoding techniques and application to xDSL systems”

If the interleaver is fixed to a length, e.g. 1088 bits, the performance of high order constellations, such as 16384 QAM, is poor.

For a spectral efficiency of 4 bit/s/Hz, a SNR of 14.0 dB for a BER of 10⁻⁷ is needed. This is equivalent to Eb/No of 8.0 dB. This provides an extra coding gain of 4 dB with respect to the TCM operation mode. In practical applications this means one additional bit per tone. In a DMT system, if 100 DMT tones are used, this is translated to 4000 symbols/s * 100 tones/ symbol * 1.25 bit/tone=500,000 bits/s more than the TCM operation mode. If 4096 tones are used this is translated to 4000 symbols/s * 4096 tones/ symbol * 1.25 bit/tone=20,480,000 bits/s more than the TCM operation mode.

In this mode of operation, for a spectral efficiency of 12 bit/s/Hz, a SNR of 39.3 dB for a BER of 10⁻⁷ is needed. This is equivalent to Eb/No of 28.5 dB. This provides an extra coding gain of 2.7 dB with respect to the TCM operation mode. in practical applications this means almost one additional bit per tone.

In a DMT system, if 100 tones are used this is translated to 4000 symbols/s * 100 tones/ symbol * 0.85 bit/tone=340,000 bits/s more than the TCM operation mode. If 4096 tones are used this is translated to 4000 symbols/s * 4096 tones/ symbol * 0.85 bit/tone=13,926,400 bits/s more than the TCM operation mode.

The same principle and very similar results are applicable to Serially Concatenated Convolutional Codes and RA (Repeat-Accumulative codes).

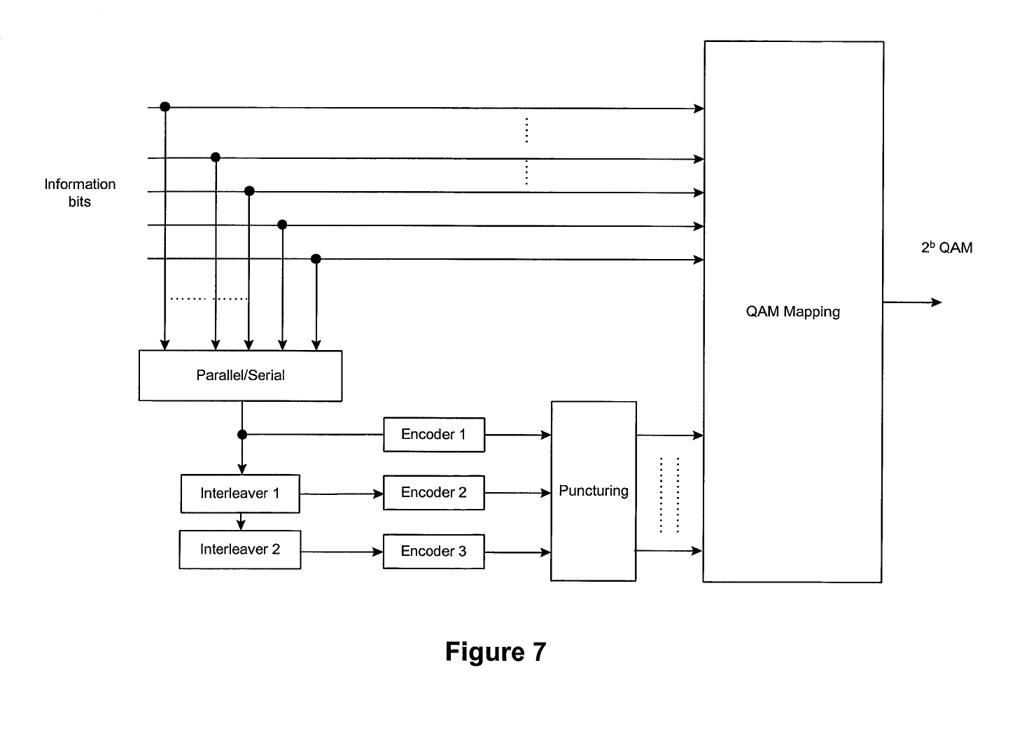

A variant of this method using 2 interleavers and 3 concatenated codes is shown in FIG. 7, where 3 parity bits are used. This variant requires less complex concatenated convolutional encoders for an equivalent performance.

In a DMT system the interleavers are a configured integer number of DMT symbols.

The use of low number of convolutional encoder states implies less computational complexity and lower performance. A high number of convolutional encoder states requires more computational complexity, but provides better performance.

Larger interleave size provides better performance but more latency.

For applications with a target BER below 10⁻⁷ in an AWGN channel, it is better to protect more the parity bits. For applications with a target BER higher than 10⁻⁷ the protection of the information bits is more important in an AWGN channel. For Impulse noise channels the greater protection of parity bits provides better performance in all cases as it can be seeing in the U.S. patent application Ser. No. 09/846,061 entitled “Use of turbo-like codes for QAM modulation using independent I and Q decoding techniques and application to xDSL systems”.

In this case the parameters of the operational mode that the receiver indicates to the transmitter are: number of coders (2, 3), number of states of each coders (4, 8 or 16), polynomial that characterize the encoders in octal (e.g. 5/7, 15/17, 23/35), size of the interleaver (for all the interleavers) and puncturing table to use. polynomial typically indicates number of coders and number of states

2.3.2 FLTC-TPC operation mode

The FTLC-TPC operation mode is used when all the information bits are encoded with a Turbo Block code. Each row generates a parity bit pi and each column also generates a parity bit qi. This operation mode is also known as Turbo Product Code.

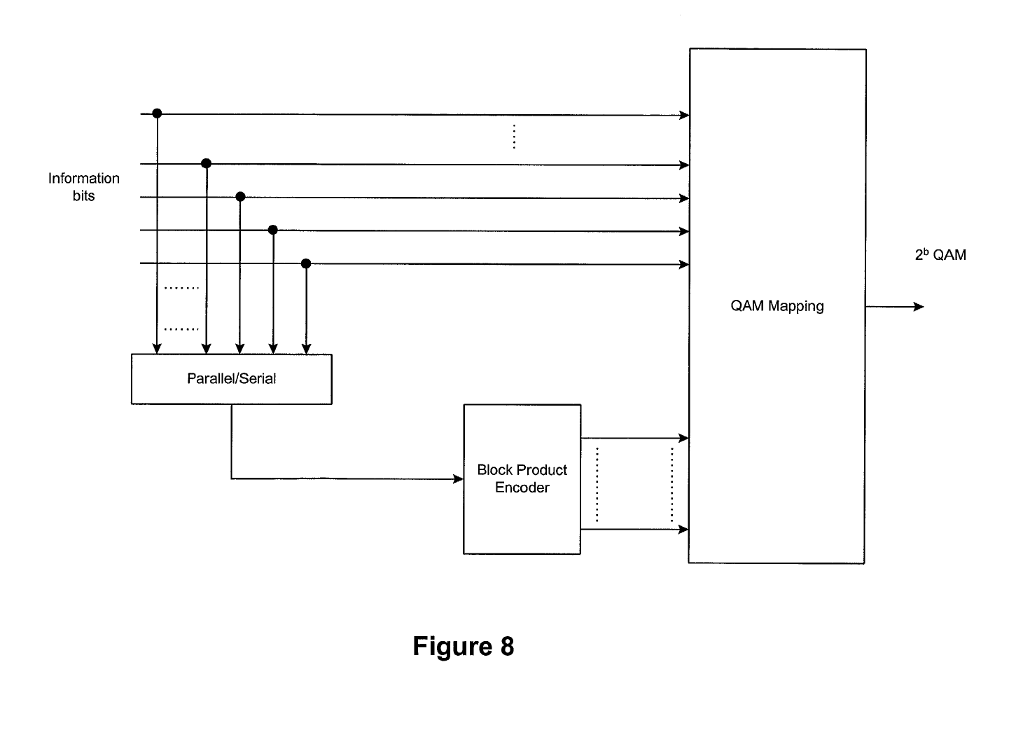

FIG. 8 shows a block diagram of the system described for the FLTC-TPC operation mode. All the information bits are sent to the Block Product encoder, that generates the pi and qi values and sends these values to the QAM Constellation encoder. The Block Product encoder has a similar function to the interleaver in the FTLC-PCCC operation mode. No puncturing is used in this case.

In this operation mode, for a spectral efficiency of 4 bit/s/Hz, a SNR of 15.5 dB for a BER of 10⁻⁷ is needed. This is equivalent to Eb/No of 9.5 dB. This provides an extra coding gain of 2.5 dB with respect to the TCM operation mode. In practical applications this means one extra bit per tone.

In a DMT system, if 100 tones are used this is translated to 4000 symbols/s * 100 tones/ symbol * 0.75 bit/tone=300,000 bits/s more than the TCM operation mode. If 4096 tones are used this is translated to 4000 symbols/s * 4096 tones/ symbol * 0.75 bit/tone=12,288,000 bits/s more than the TCM operation mode.

In this operation mode, for a spectral efficiency of 12 bit/s/Hz or more, this technique has not been proven to be efficient, for this reason this techniques is not preferred high order constellations.

In the preferred embodiment, the parameters of this mode that may be configured are the number of columns and number of rows of the block code (M, N).

2.3.3 FLTC-LDPC operation mode

The FTLC-LDPC operation mode is used when all the information bits are encoded with a block code using Low Density Parity Check Matrices. This operation mode is complex in the transmitter. The complexity in the receiver (decoding a linear code), compared with the FTLC-PCCC and FTLC-TPC operation modes, is low.

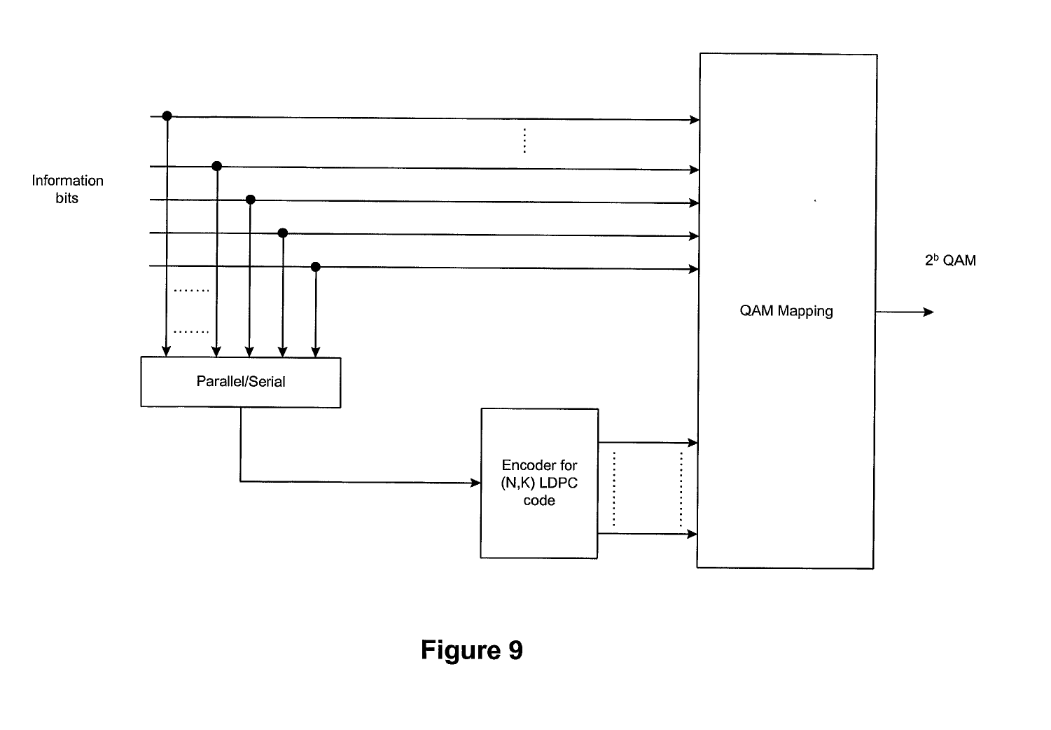

FIG. 9 shows a block diagram of the system described for the FLTC-LDPC operation mode. All the information bits are sent to the (N, K) encoder, that generates the low-density parity-check matrix.

No puncturing is used in this case. The Low Density Parity Check matrix essentially incorporated puncturing as used by a turbo-like code.

In this operation mode, for a spectral efficiency of 4 bit/s/Hz, a SNR of 16.0 dB for a BER of 10⁻⁷, is needed. This is equivalent to Eb/No of 10.0 dB. This means an extra coding gain of 2.0 dB with respect to the TCM operation mode. In practical applications this means one more extra bit per tone.

In a DMT system, if 100 tones are used this is translated to 4000 symbols/s * 100 tones/ symbol * 0.65 bit/tone=260,000 bits/s more than the TCM operation mode. If 4096 tones are used this is translated to 4000 symbols/s * 4096 tones/ symbol * 0.75 bit/tone=10,650,000 bits/s more than the TCM operation mode.

In this operation mode, for a spectral efficiency of 12 bit/s/Hz, a SNR of 39.8 dB for a BER of 10⁻⁷, is needed. This is equivalent to Eb/No of 29.0 dB. This means an extra coding gain of 2.2 dB with respect to the TCM operation mode. In practical applications this means almost one extra bit per tone.

In a DMT system, if 100 tones are used this is translated to 4000 symbols/s * 100 tones/ symbol * 0.75 bit/tone=300,000 bits/s more than the TCM operation mode. If 4096 tones are used this is translated to 4000 symbols/s * 4096 tones/ symbol * 0.75 bit/tone=12,288,000 bits/s more than the TCM operation mode.

2.4 MTLC operation mode

The MTLC operation mode is used when not all the information bits are encoded. In this case, some bits have more protection than others to noise. Turbo-like means that the decoding algorithm uses soft decisions. In this operation mode, like in the FTLC operation mode, some sub-modes are possible such as the parallel concatenated convolutional codes, serial concatenated convolutional codes, Block Product codes, Low Density Parity Check codes, Repeat Accumulate Codes, etc.

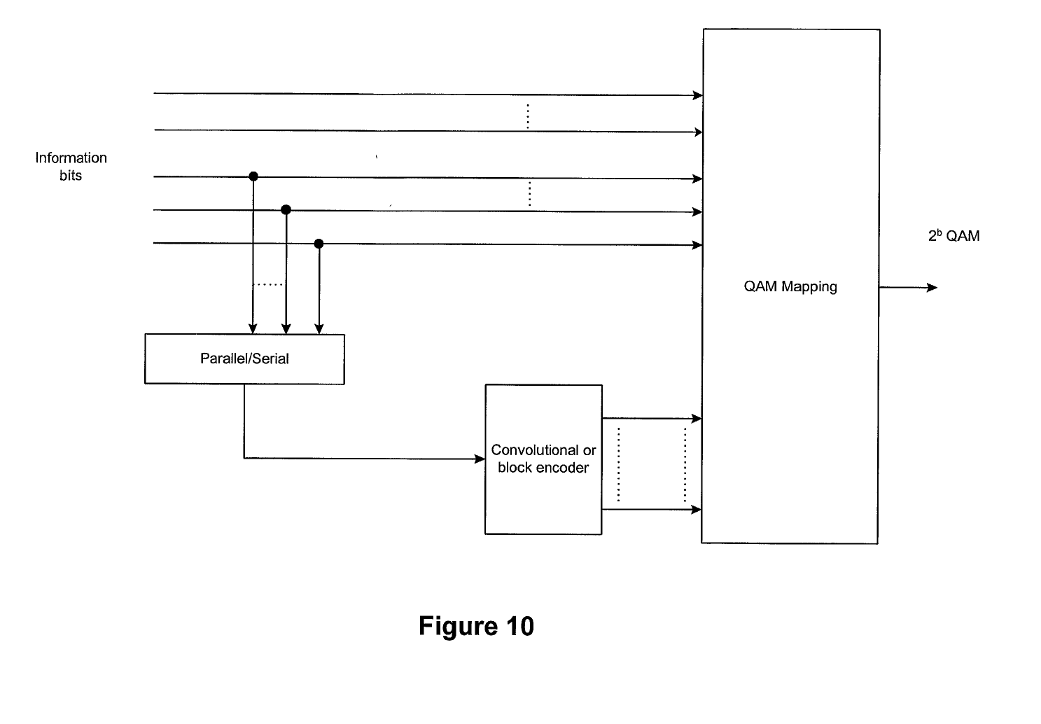

FIG. 10 shows a block diagram of the system described for the MTLC operation mode. Note that some information bits are not sent to the parallel/serial converter or to the convolutional or block encoder.

The LDPC parity-check matrix H is defined by three parameters: a prime number p and two integers k and j such that k, j>p. The matrix H has dimensions jp×kp and is given by:

$$H = [ \begin{matrix}I & I & I & … & I & I & … & I \\ 0 & I & α & … & {α}^{j - 2} & {α}^{j - 1} & … & {α}^{k - 2} \\ 0 & 0 & I & … & {α}^{2 ( j - 3 )} & {α}^{2 ( j - 2 )} & … & {α}^{2 ( k - 3 )} \\ … & … & … & … & … & … & … & … \\ 0 & 0 & … & 0 & I & {α}^{( j - 1 )} & … & {α}^{( j - 1 ) ( k - 1 )}\end{matrix} ]$$

where/is the p×p identity matrix, O is the p×p null matrix, and α is the p×p permupermutation matrix representing a single left shift. For example, for p=5,

$$α = [ \begin{matrix}0 & 0 & 0 & 0 & 1 \\ 1 & 0 & 0 & 0 & 0 \\ 0 & 1 & 0 & 0 & 0 \\ 0 & 0 & 1 & 0 & 0 \\ 0 & 0 & 0 & 1 & 0\end{matrix} ]$$

LDPC codes defined by H have code word length N=kp, number of parity checks M=jp, and information block length K=(k−j)p. The parity-check matrix of an LDPC with code word length N′<N or number of parity checks M′<M can be obtained by discarding the N−N′ rightmost columns and the M−M′ lowest rows of H, respectively. Thus five parameters must be specified to define the LDPC code: p, j, k, the code word length and the number of parity checks.

Efficient encoding is achieved directly from the parity-check matrix H without the need to compute the generator matrix of the code. To this end, an LDPC codeword is expressed in the form:

(x_{N-1}, x_{N-2}, . . . . x₀)=(P_{N-K-1}, P_{N-K-2}, . . . , P₀. d_{K-1}, d_{K-2}, . . . , d₀)

where (P_{N-K-1}, P_{N-K-2}, . . . , P₀) represents the parity part and (d_{K-1}, d_{K-2}, . . . , d₀) the systematic part of the code word. The parity bits (P₀, P₁, . . . , P_{N-K-1})are recursively computed (in that order) using the constraint:

H·(x_{N-1}, x_{N-2}, . . . , x₀)^{T}=0

where T denotes vector transpose and the right-hand side of the equation represents the null vector.

In this mode, the parameters p, k and j are configurable.

2.4.1 MLTC-PCCC operation mode

The MTLC-PCCC operation mode is used when some of the information bits are encoded with Parallel Concatenated Convolutional Codes (PCCC). This operation mode is also known as Multilevel Turbo Code.

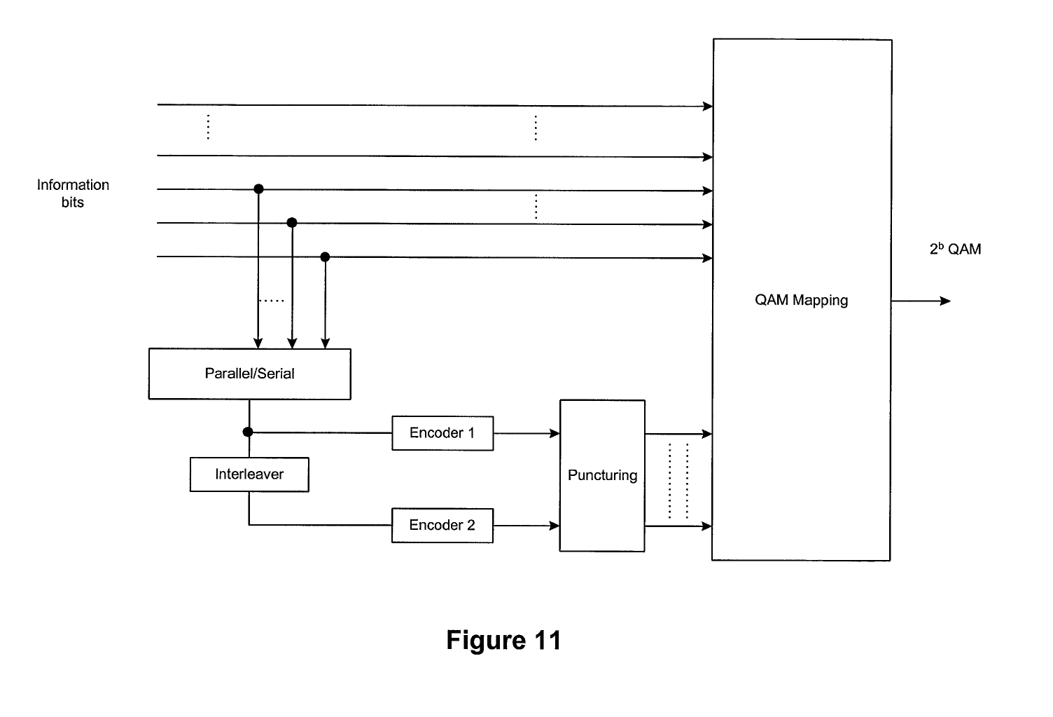

FIG. 11 shows a block diagram of the system described for the MLTC-PCCC operation mode. Some of the information bits are sent to encoder 1 and to the interleaver. After the bits are interleaved, they are sent to encoder 2. The parity bits from encoder 1 and encoder 2 are sent to the Puncturing block, that in function of the QAM constellation used, selects a different puncturing pattern as is described in the International application No. PCT/US99/17369, “Method and Apparatus for Design Forward Error Correction Techniques in Data Transmission over communications Systems” incorporated herein by reference. The puncturing block selects the parity bits that are sent to the channel.

The interleaver block is very important in the system. The design of this interleaver is explained in the U.S. patent application Ser. No. 09/846,061 entitled “Use of turbo-like codes for QAM modulation using independent I and Q decoding techniques and application to xDSL systems”. It is designed to ensure a fixed latency in the system with the best performance.

In a DMT system, the length of the interleaver is variable depending on the data rate, and may be set to an integer multiple of DMT symbols, in other words, set to a multiple of the number of coded bits carried by a DMT symbol. For practical implementations of the interleaver for latencies below 10 ms, the interleaver length could be set to 14 DMT symbols or smaller integer number.

Use of a low number of convolutional encoder states involves less computational complexity but lower performance. A high number of convolutional encoder states requires more computational complexity, but provides better performance. Larger interleave size provide better performance but more latency.

For applications with a target BER below 10⁻⁷ in an AWGN channel, it is better to protect more the parity bits. For applications with a target BER higher than 10⁻⁷ the protection of the information bits is more important in an AWGN channel. For impulse noise channels the greater protection of parity bits provides better performance in all cases.

In this operation mode, for a spectral efficiency of 4 bit/s/Hz, a SNR of 17.5 dB for a BER of 10⁻⁷, is needed. This is equivalent to Eb/No of 11.5 dB. This means an extra coding gain of 0.5 dB with respect to the TCM operation mode. In practical applications this means one extra bit per tone.

In a DMT system if 100 tones are used this is translated to 4000 symbols/s * 100 tones/ symbol * 0.1 bit/tone=40,000 bits/s more than the TCM operation mode. If 4096 tones are used this is translated to 4000 symbols/s * 4096 tones/ symbol * 0.1 bit/tone=1,600,000 bits/s more than the TCM operation mode.

In this operation mode, for a spectral efficiency of 12 bit/s/Hz, a SNR of 41.8 dB for a BER of 10⁻⁷ is needed, this is equivalent to Eb/No of 31.0 dB. This means an extra coding gain of 0.2 dB with respect to the TCM operation mode.

In a DMT system if 100 tones are used this is translated to 4000 symbols/s * 100 tones/ symbol * 0.05 bit/tone=20,000 bits/s more than the TCM operation mode. If 4096 tones are used this is translated to 4000 symbols/s * 4096 tones/ symbol * 0.05 bit/tone=800,000 bits/s more than the TCM operation mode.

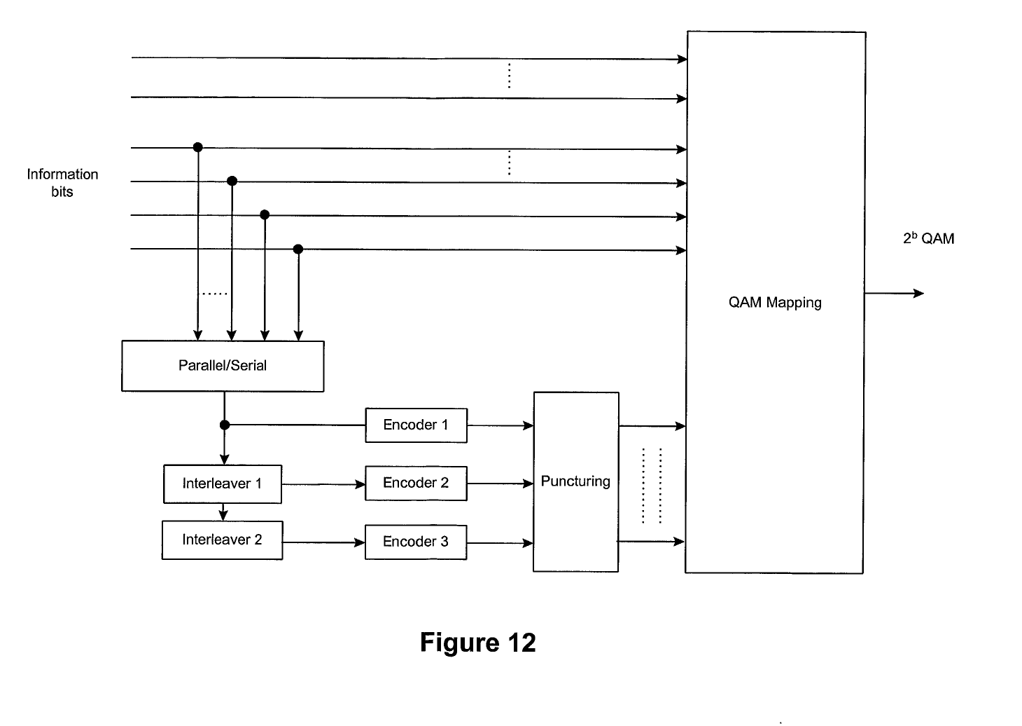

A variant of this method using 2 interleavers and 3 convolutional coders is shown in FIG. 12, where 3 parity bits are used. This variant requires less complex concatenated convolutional encoders for an equivalent performance.

In this mode the parameters that may be configured are: number of bit to encode, number of coders (2, 3), number of estates of each coders (4, 8 or 16), polynomial that characterize the encoders in octal (e.g. 5/7, 15/17, 23/35), size of the interleaver (for all the interleavers) and puncturing table to use.

2.4.2 MLTC-TPC operation mode

The MTLC-TPC operation mode is used when some of the information bits are encoded with a block code. Each row generates a parity bit, called pi, and each column generates a parity bit, called qi. This operation mode is also known as Multilevel Turbo Product Code.

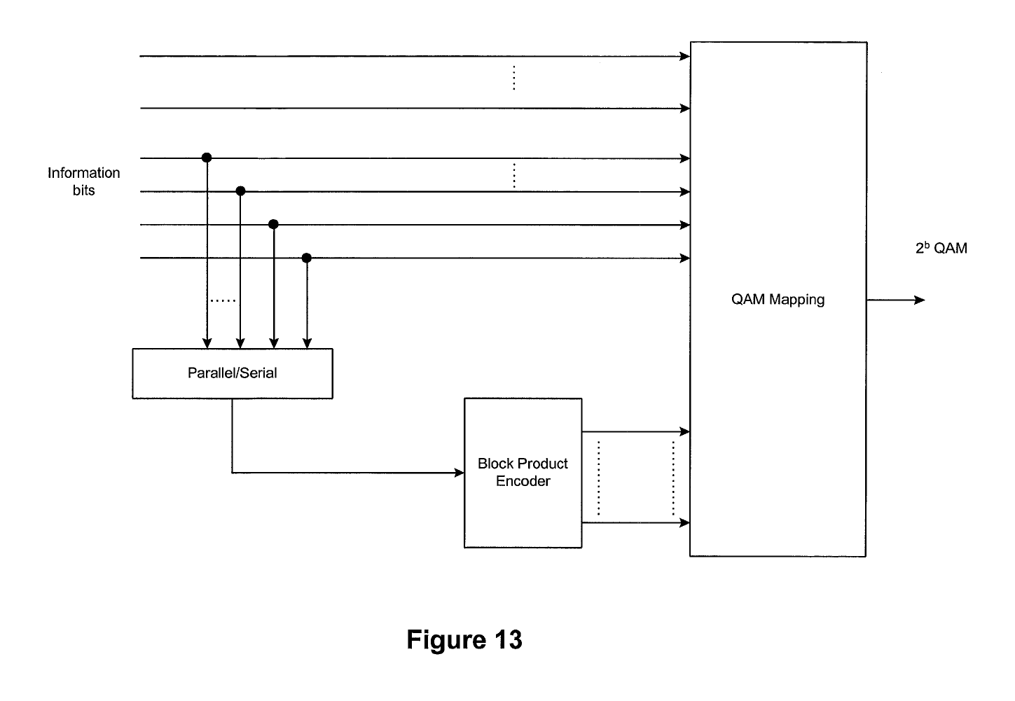

FIG. 13 shows a block diagram of the system described for the MLTC-TPC operation mode. Some of the information bits are sent to the Block Product Encoder, that generates the pi and qi values and sent these values to the QAM Constellation Encoder. The Block Product Encoder has a similar function to the interleaver in the MTLC-PCCC operation mode. No puncturing is used in this case.

In this mode the parameters that may be configured are: number of bits to encode n, number of columns and number of rows of the block code (M, N).

2.4.3 MLTC-LDPC operation mode

The FTLC-LDPC operation mode is used when some of the information bits are encoded with a block code using Low Density Parity Check matrices. This operation mode is complex in the transmitter. In the receiver, the complexity is low compared with the MTLC-PCCC and MTLC-TPC operation modes.

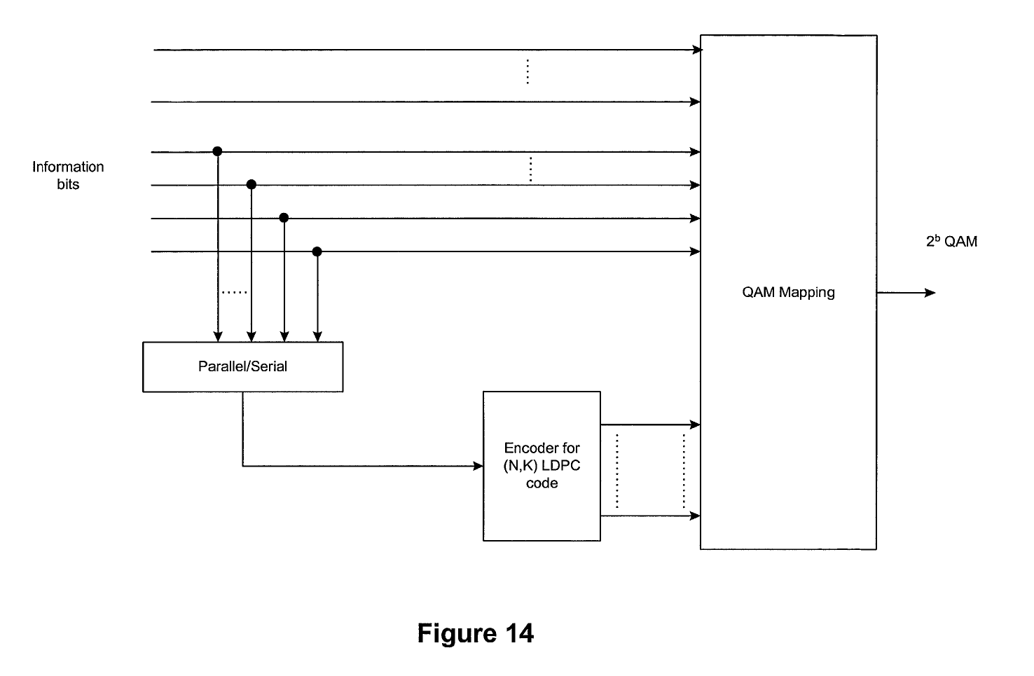

FIG. 14 shows a block diagram of the system described for the MLTC-LDPC operation mode. All the information bits are sent to the (N, K) encoder that generates the parity check matrix.

No puncturing is used in this case. The Low Density Parity Check matrix includes the puncturing, from a theoretical point of view.

In this operation mode, for a spectral efficiency of 4 bit/s/Hz, a SNR of 17.0 dB for a BER of 10⁻⁷, is needed. This is equivalent to Eb/No of 11.0 dB. This means an extra coding gain of 1.0 dB with respect to the TCM operation mode.

In a DMT system, if 100 tones are used this is translated to 4000 symbols/s * 100 tones/ symbol * 0.4 bit/tone=160,000 bits/s more than the TCM operation mode. If 4096 tones are used this is translated to 4000 symbols/s * 4096 tones/ symbol * 0.4 bit/tone=6,550,000 bits/s more than the TCM operation mode.

In this operation mode, for a spectral efficiency of 12 bit/s/Hz, a SNR of 40.8 dB for a BER of 10⁻⁷, is needed. This is equivalent to Eb/No of 30.0 dB. This means an extra coding gain of 1.2 dB with respect to the TCM operation mode.

In a DMT system, if 100 tones are used this is translated to 4000 symbols/s * 100 tones/ symbol * 0.4 bit/tone=160,000 bits/s more than the TCM operation mode. If 4096 tones are used this is translated to 4000 symbols/s * 4096 tones/ symbol * 0.4 bit/tone=6,588,000 bits/s more than the TCM operation mode.

The parameters that are configurable in this mode are: number of bits to encode n, and LDPC parameters p, k and j.

3. Structure of the encoder for Concatenated Convolutional Codes

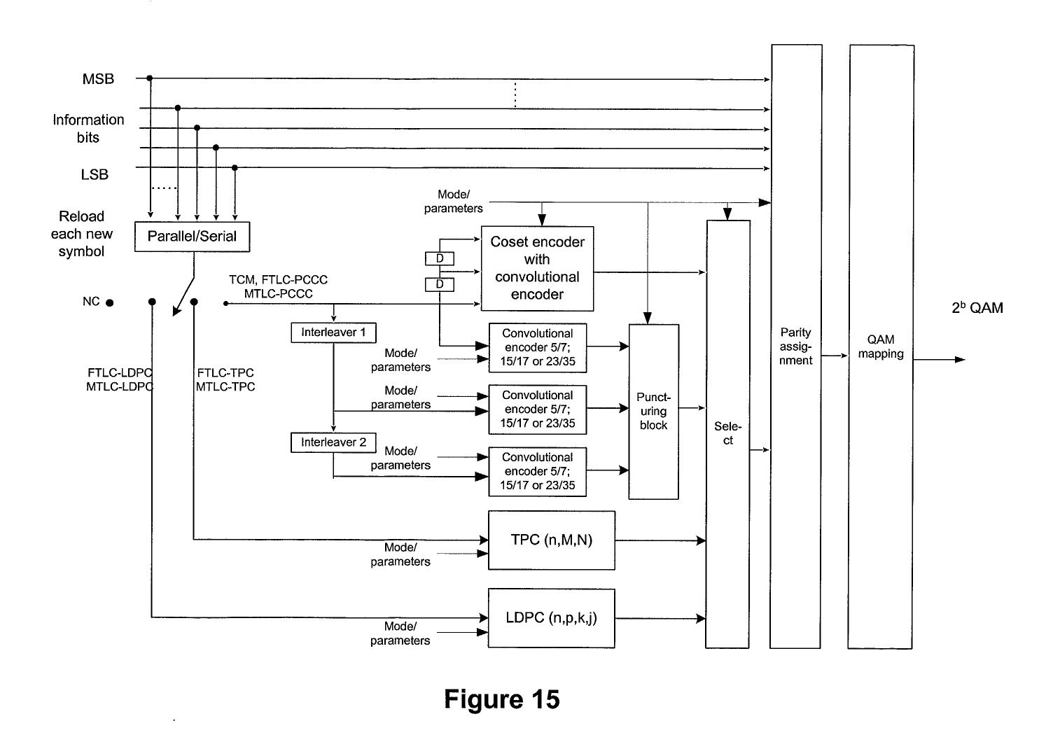

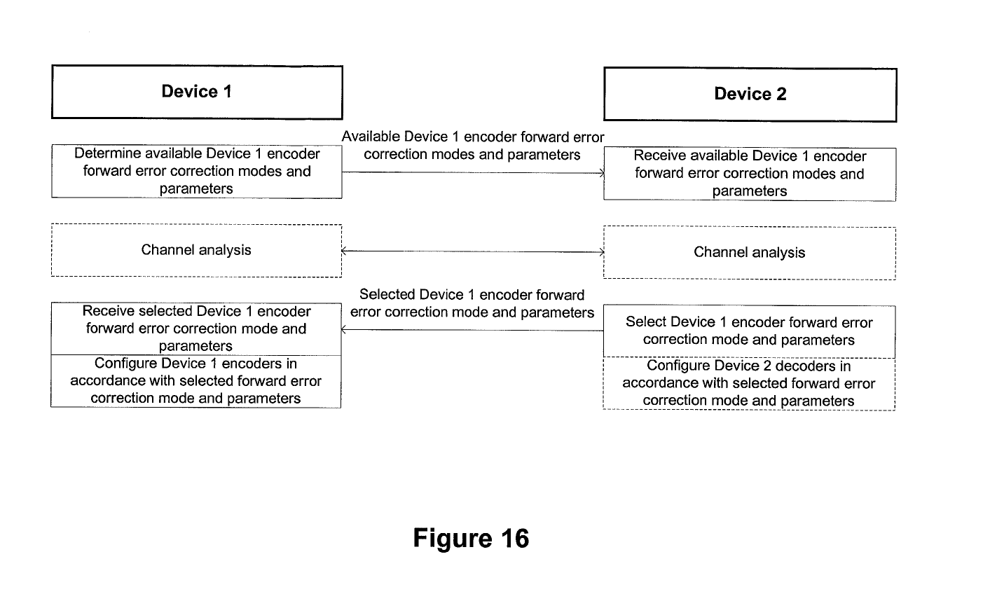

The various modes of operation described in section 2 are provided in the preferred hardware embodiment by a device as shown in FIG. 15.

As shown in FIG. 15, all information bits for every symbol are sent to a parallel/serial block. A coset encoder that includes a convolutional coder as defined in G.992.1 runs at a symbol rate and produces cosets bits as defined in G.991.1. Three concatenated convolutional encoders run at N times the symbol rate, where N is the number of information bits being encoded, and produce parity bits. These parity bits are provided to a puncturing block section that determines which of the parity bits are mapped along with the information bits. A select section multiplexes output bits of the coset encoder and the puncturing block. In the illustrated hardware implementation of the preferred embodiment, all encoders operate for each group of information bits, in accordance with specified parameters, and the operation of the select section determines which encoder mode scheme is provided. In a software implementation of the preferred embodiment, only those coders that are needed for a given mode are operated.

A parity assignment section receives the information bits and the output of the select section and assigns the location of the parity bits within the information bits. The Parity Assignment block decides which bits are more protected, depending of the application. Providing more protection to the information bits, means that in the mapping, the probability of the information bits having an error is lower than the probability of the parity bits having an error. Providing more protection to the parity bit(s) means that in the mapping, the probability of the parity bit(s) having an error is lower than the probability of the information bits having an error. Assigning a bit to a constellation index most significant bit provides more protection, where the constellation index bits correspond to the magnitude-step of the symbol. For applications with a target BER below 10⁻⁷ in an AWGN (Additive White Gaussian Noise) channel, it is better to protect more the parity bits. For applications with a target BER higher of 10⁻⁷, the protection of the information bits is more important in an AWGN channel. For Impulse noise channels, the greater protection of parity bits provides better performance in all cases.

A QAM mapping section maps information and parity bits to QAM constellation symbols.

The preferred embodiment illustrated in FIG. 15 can be configured to provide five different modes of forward error correction. In the following modes, all information bits are encoded: FTLC-TPC (full turbo like code); FTLC-LDPC; FTLC-PCCC (parallel concatenated convolutional coder—the three parallel coders). In the following modes, less than all information bits are encoded (recommended where the constellation has more than four bits in each dimension): MTLC-TPC (multilevel turbo-like code); MTLC-LDPC.

In the case that two interleavers are used, the first Convolutional Encoder can be set to 4 states, the second and third Convolutional Encoder to 8 states, providing good performance.

In the case that the second interleaver is not used, if the first and second Convolutional Encoder are both set to 8 states, the performance is good for high order constellations, such as 8, 10 or 12 bits. For lower order constellations, such as 6 bits, the use of 16 states convolutional encoder can provide an extra coding gain of 1.8 dB. The performance with 4 states is poor.

For a DMT system, Table 1 summarizes the extra data rate, in Mbps, with respect to the TCM operation mode for each operation mode, for ADSL applications (100 tones) and for VDSL applications (4096 tones).

TABLE 1
Extra data rate in Mbps with respect to Trellis Code Modulation

| | | | 12 | 12 |
|---|---|---|---|---|
| operation | 4 bit/symbol | 4 bit/symbol | bits/symbol | bits/symbol |
| mode | ADSL | VDSL | ADSL | VDSL |
| FLTC-PCCC | 0.50 | 20.40 | 0.34 | 13.92 |
| FLTC-TPC | 0.30 | 12.28 | — | — |
| FLTC-LDPC | 0.26 | 10.65 | 0.30 | 12.29 |
| MLTC-PCCC | 0.04 | 1.6 | 0.02 | 0.8 |
| MLTC-LDPC | 0.16 | 6.5 | 160 | 6.5 |

4. Interactive configuration processes

Communication devices as described above may perform interactive configuration processes to configure the forward error correction mode in one or both of the communication devices. FIG. 16 illustrates an example of a configuration process in the preferred embodiment, in which the forward error correction mode and parameters of a first communication device labeled Device 1 are configured by a second communication device labeled Device 2. As shown in FIG. 16, Device 1 first determines available forward error correction modes and parameters. The available modes and parameters may comprise all modes and parameters that the device is capable of, or may be a limited subset of those modes and parameters. The available modes and parameters are communicated to Device 2. Device 2 then optionally performs channel analysis interactively with Device 1 to determine the quality of the channel linking the devices. Device 2 then communicates a selected forward error correction mode and selected forward error correction parameters to Device 1. Upon receiving the selected mode and parameters, Device 1 configures its encoders to provide the selected forward error correction mode in accordance with the selected forward error correction parameters. In the preferred embodiment, Device 2 includes a configurable decoder and configures its decoder to decode in accordance with the selected forward error correction mode. However, in alternative embodiments, Device 2 may have a fixed decoder mode, such that its selection of a Device 1 mode simply reflects the available decoding in Device 2.

While FIG. 16 shows the configuration of Device 1 based on a selection made by Device 2, in a further embodiment the process may be bidirectional such that the forward error correction mode of Device 2 is configured in a similar manner based on a selection made by Device 1.

In an alternative embodiment, the configurable forward error correction modes of Device 1 may be provided to enable other types of devices having various single decoding modes to communicate with Device 1. In those instances it may not be necessary for Device 1 to inform those devices of its available modes. Rather, such devices may simply request communication using a specified mode of forward error correction, and the device receiving the request may elect to provide communication in that mode or provide no communication, based on its particular capabilities or other factors.

The available modes determined by Device 1 need not include all modes of which Device 1 is capable. Rather, Device 1 may determine a subset of its modes to be made available to Device 2 for its selection. This determination may be based on a number of different factors. For example, Device 1 may make modes available based on Device 1 power requirements, such as the power required to provide a particular connection or limitations on maximum device power in view of all connection being handled. Modes may also be made available based on signal quality factors such as signal level, noise level and the length of the connection. Device processing limitations, such as the inability of the device to provide more than a fixed number of connections in a given mode, may also be considered. In further embodiments, the set of parameters made available may be based on similar considerations. In other embodiments, only the mode of forward error correction may be made configurable by another device, with default parameters being determined by the device being configured.

5. Asymmetric forward error correction

The configuration processes described above may result in connections in which two communicating devices are using different forward error correction modes. This is described as an asymmetric connection. Such a system need not be implemented through an interactive configuration process as described above, but may instead be manually configured. In such a system, a first communication device communicates with a second communication device. The first communication device encodes its output in accordance with a first forward error correction mode, and the second device decodes signals received from the first communication device in accordance with that first forward error correction mode. At the same time, the second communication device encodes its output in accordance with a second forward error correction mode that is different from the first forward error correction mode, and the first device decodes signals received from the second communication device in accordance with the second forward error correction mode.

Communication devices in such systems may therefore implement different forward error correction modes in their transmit and receive circuits. For example, a communication device may have a turbo-like encoder in its transmit circuit, and a low density parity check decoder in its receive circuit. In another alternative, a communication device may have a low density parity check encoder in its transmit circuit, and a turbo-like decoder in its receive circuit.

While the embodiments described herein include various combinations of features, those features may characterize further embodiments of the invention individually or in other combinations, and thus it will be apparent to those having ordinary skill in the art that the system features and processing tasks described herein are not necessarily exclusive of other features and processing tasks, nor required to exist in only those combinations particularly described, but rather that further alternative combinations may be implemented and that additional features and tasks may be incorporated in accordance with particular applications. Therefore it should be understood that the embodiments described herein are offered by way of example only. The invention is not limited to these particular embodiment, but extends to various modifications, combinations, and permutations that fall within the scope and spirit of the appended claims.

What is claimed is:

1. A method in a communication device of a communications system, comprising:
determining a plurality of available forward error correction modes of the communication device;
communicating the plurality of available forward error correction modes to another communication device of the communications system;
receiving a selected forward error correction mode from the other communication device; and
configuring the communication device to produce output in accordance with the received forward error correction mode.

2. The method claimed in claim 1, wherein said available forward error correction modes include at least two of convolutional coding (CC), trellis code modulation (TCM), full turbo-like code (FTLC), multilevel turbo-like code (MTLC), full Low-Density Parity Check codes (FLDPC) and Multi-Level Low Density Parity Check Code (MLDPC).

3. The method claimed in claim 1, wherein said available forward error correction modes include at least one low density parity check mode.

4. The method claimed in claim 1, wherein determining available forward error correction modes comprises:
determining forward error correction modes that the communication device is capable of providing; and
determining a subset of the forward error correction modes that the communication device is capable of providing as said available forward error correction modes.

5. The method claimed in claim 4, wherein said determination of said subset of modes is based on at least one of communication device power requirements, signal quality, and communication device processing limitations.

6. The method claimed in claim 1, further comprising:
determining parameters that the communication device is capable of providing for each of said available forward error correction modes;
determining respective subsets of parameters that the communication device is capable of providing for each of said available forward error correction modes as respective available forward error correction mode parameters; and
communicating the respective available forward error correction mode parameters to the other communication device of the communications system.

7. The method claimed in claim 6, wherein said determination of said subset of parameters is based on at least one of communication device power requirements, signal quality, and communication device processing limitations.

8. The method claimed in claims 6, further comprising:
receiving a selected set of parameters corresponding to a selected forward error correction mode; and
wherein said configuring comprises configuring the communication device to produce output in accordance with the received forward error correction mode and the received forward error correction parameters.

9. A method in a communication device of a communications system, comprising:
receiving data representing a plurality of available forward error correction modes of another communication device of the communication system;
selecting one of said plurality of modes; and
transmitting data to the other communication device representing the selected forward error correction mode.

10. The method claimed in claim 9, wherein said plurality of available forward error correction modes includes at least one low density parity check mode.

11. The method claimed in claim 9, further comprising:
receiving data representing respective sets of available parameters for said plurality of available forward error correction modes;
selecting one of said sets of parameters corresponding to a selected forward error correction mode; and
transmitting data to the other communication device representing the selected set of parameters.

12. The method claimed in claim 10, further comprising configuring an at least one decoder of the communication device to decode received communication signals in accordance with the selected mode and the selected parameters.

13. The method claimed in claim 9, further comprising configuring at least one decoder of the communication device to decode received communication signals in accordance with the selected mode.

14. A communication device comprising:
a plurality of coders and a plurality of interleavers, said coders and interleavers being configurable to provide a plurality of forward error correction modes; and
a mode selection section providing mode selection signals to said plurality of coders in accordance with forward error correction mode selection data received from another communication device.

15. The communication device claimed in claim 14, wherein said available forward error correction modes include at least two of convolutional coding (CC), trellis code modulation (TCM), full turbo-like code (FTLC), multilevel turbo-like code (MTLC), full Low-Density Parity Check codes (FLDPC) and Multi-Level Low Density Parity Check Code (MLDPC).

16. The communication device claimed in claim 14, further comprising a mode availability determination section for determining a subset of said plurality of modes to be communicated to said other communication device as available forward error correction modes.

17. The communication device claimed in claim 14, further comprising a puncturing block section for selecting parity bits to be transmitted.

18. The communication device claimed in claim 17, further comprising a select section for multiplexing outputs of the plurality of coders to provide one of said modes.

19. The communication device claimed in claim 18, further comprising a parity assignment section for assigning parity bits to positions within groups of information bits.

20. The communication device claimed in claim 19, further comprising a QAM mapping section for mapping output data to symbols of a QAM transmission constellation.

21. The communication device claimed in claim 14, wherein said communication device is implemented as a data processing device operating in accordance with programming instructions for providing said coders, interleavers and sections.

22. An asymmetric communications system comprising:
a first communication device communicating with a second communication device,
the first communication device encoding output in accordance with a first forward error correction mode, and the second device decoding signals received from the first communication device in accordance with said first forward error correction mode, and
the second communication device encoding output in accordance with a second forward error correction mode different from said first forward error correction mode, and the first device decoding signals received from the second communication device in accordance with said second forward error correction mode.

23. The system claimed in claim 22, wherein each of said first and second forward error correction modes comprises one of convolutional coding (CC), trellis code modulation (TCM), full turbo-like code (FTLC), multilevel turbo-like code (MTLC), full Low-Density Parity Check codes (FLDPC) and Multi-Level Low Density Parity Check Code (MLDPC).

24. The system claimed in claim 22, wherein the first forward error correction mode of the first communication device is turbo-like code, and
wherein the second forward error correction mode of the second communication device is low density parity check code.

25. A communication device comprising:
a transmit circuit and a receive circuit,
the transmit circuit including an encoder providing forward error correction for transmitted bits using turbo-like coding, and
the receive circuit including a decoder providing forward error correction decoding for received bits using low density parity check decoding.

26. A communication device comprising:
a transmit circuit and a receive circuit,
the transmit circuit including an encoder providing forward error correction for transmitted bits using low density parity check coding, and
the receive circuit including a decoder providing forward error correction decoding for received bits using turbo-like decoding.
